(19) United States
(12) Patent Application Publication
(10) Pub. No.: US 2006/0121259 A1
(43) Pub. Date: Jun. 8, 2006

(54) White polymeric film with improved machinability and reduced dusting

(76) Inventor: David Randall Williams, Fairport, NY (US)

Correspondence Address: Exxonmobile Chemical Company;Law Technology, P.O. Box 2149, Baytown, TX, 77522-2149, US

(21) Appl. No.: 11/001,756

(22) Filed: Dec. 2, 2004

(51) Int. Cl. B32B 27/08; B32B 27/32

(52) U.S. Cl. 428/216; 428/411.1; 428/516; 428/521

(57) ABSTRACT

Coextruded polymeric films having improved machinability and a reduced propensity to release cavitating agent particles during processing and handling of the film are provided. The films are particularly useful as labelstock and especially roll feed labelstock. The films are comprised of multiple coextruded layers, including at least one skin layer cavitated with calcium carbonate and incorporating a silicon gum. The films exhibit improved machinability and while at same time exhibiting a reduced propensity to release a cavitating agent as “dust” from the cavitated skin layer during film processing and handling.

### FIELD OF THE DISCLOSURE

This disclosure relates to white polymeric films having improved machinability characteristics and reduced propensity to release cavitating agent particles during processing and handling of the film.

### BACKGROUND INFORMATION

Coextruded polymeric films having layers voided with a cavitating agent are well known. For example, it is known to simultaneously extrude multiple layers, and thereafter orient the extruded structure (which causes cavitation of any layer including a cavitating agent). A variety of cavitating agents are known to be useful to bring about the cavitation. Different cavitating agents can be employed under particular processing conditions to obtain desired opaque polymeric films. Attempts to vary the types of cavitating agents have been made to improve opacity and machinability of polymeric films. For example, U.S. Pat. Nos. 4,758,462 and 5,176,954 disclose the use of organic polymers such as polybutylene terephthalates as cavitating agents in polypropylene matrix materials. U.S. Pat. No. 4,758,462 to Park relates to polymeric films of enhanced opacity and methods of making the same. The films of the Park patent are made with a thermoplastic polymer matrix material within which is located a stratum of voids. U.S. Pat. No. 6,242,084 to Peet discloses that voids may be created by calcium carbonate cavitating agents. U.S. Pat. No. 5,176,954 to Keller et al., is directed to a non-symmetrically layered, highly opaque, biaxially oriented polymer film having a core layer which contains polybutylene terephthalate cavitating agents, as well as iron oxide, aluminum, and titanium dioxide. The polybutylene terephthalates described in the above patents, are good cavitating agents that can be processed at high temperatures (i.e., temperatures higher than the melting point of the matrix material). Polybutylene terephthalates, however, are sensitive to hydrolytic breakdown, and thus can degrade into lower molecular weight materials. These low molecular weight materials have been known to migrate to surfaces of processing apparatus, e.g., melt pipes, filters, dies, etc. These materials build up and can then eventually slough off the metal surfaces and pass into the films as sizable deposits of hard, eggshell-type impurities which cause the film to split. Nylon cavitating agents, on the other hand, are not as likely to undergo hydrolytic breakdown and dispersion. However, nylon cavitating agents cannot generally be used at high temperatures. For example, U.S. Pat. No. 4,377,616 discloses that when nylons are used as cavitating agents in a polymeric matrix, the drawing temperature of the film can be quite close to the melting point of the polymeric matrix material. Attempts have also been made to use other cavitating agents with a polymeric matrix to produce opaque, oriented films. In U.S. Pat. Nos. 5,134,173 and 5,188,777 to Joesten, cross-linked polystyrenes are used as cavitating agents to make opaque, biaxially oriented polymeric films. U.S. Pat. No. 6,048,608 to Peet discloses the use of particles of a cyclic olefinic copolymers as cavitating agents.

In many applications the cavitated layer is an internal layer such a core layer. An exemplary film of this type is disclosed in U.S. Pat. No. 5,662,985 to Jensen. However, certain applications for films require that the cavitated layer be an external layer of the film structure. U.S. Pat. No. 4,965,123 to Swan discloses a film incorporating voids into at least one of the exterior layers of the film through the use of inorganic void-initiating particles. The Patent discloses the coefficient of friction of the surface of that skin layer can be significantly reduced, thus extending the range of operability of such a film in processing equipment. The '123 Patent discloses that films utilized in certain label making operations, a skin layer surface may, through frictional contact, adhere to an excessive degree to the label processing equipment, resulting in labels of poor quality and/or equipment shut-down.

U.S. Pat. No. 5,204,179 to Baker discloses a multiple layered polyolefin structure in which an outer layer incorporates a filler, although the layer is not oriented or cavitated. U.S. Pat. No. 6,054,218 to Nucci discloses the inclusion of calcium carbonate in the outer layer of a film structure to simulate a paper surface. U.S. Pat. No. 6,582,810 to Heffelfinger discloses a film structure having a “breathable” outer layer cavitated with calcium carbonate.

Various friction reducing agents have been utilized to improve the machinability of oriented film structures. See, for example, U.S. Pat. No. 4,965,123, discussed above and U.S. Pat. Nos. 4,618,527 and 4,654,252 to Doyen.

Other references disclose the use of friction reducing agents to reduce blocking between adjacent film layers during storage and handling. U.S. Pat. No. 5,891,555 to O'Brien discloses the use of silicone oils and anti-blocking agents to reduce blocking in oriented films. Similarly, U.S. Pat. No. 6,472,077 PCT to Cretekos and PCT Application WO 02/40269 disclose the use of silicone gums to reduce blocking between a skin layer and an opposite functional layer of a film. U.S. Pat. No. 5,397,635 to Wood discloses reducing blocking and film-to-film friction by inclusion of a small percentage of finely subdivided inorganic material in a polyolefin skin layer.

### BRIEF DESCRIPTION OF THE DISCLOSURE

This disclosure relates to coextruded polymeric films having improved machinability and a reduced propensity to release cavitating agent particles during processing and handling of the film. The films are found to be particularly useful as labelstock and especially roll feed labelstock. The films described herein incorporate multiple coextruded layers, including at least one skin layer that is cavitated with calcium carbonate that also incorporates a silicon gum. The coextruded films also incorporate at least on other layer that is a core layer.

The films exhibit improved machinability performance during unwinding while at the same time exhibiting a reduced propensity to release cavitating agents as “dust” from the cavitated skin layer during film processing and handling.

### DETAILED DESCRIPTION OF THE INVENTION

This disclosure relates to multiple layered coextruded polymeric films having improved machinability resulting from reduced coefficient of friction between a first skin layer of the film and process equipment. The first skin layer of the film is adjacent to a core layer of the film and includes a calcium carbonate cavitating agent and a silicone gum. By use of the term adjacent, it is understood that one or more intermediate or tie layers may be disposed between the core and skin layer. In addition to exhibiting reduced coefficient of friction to process equipment, the films display a reduced propensity to release cavitating agent particles from the first skin layer during processing and handling of the film. These effects are a surprising result. Without being bound by theory, it is believed that the combination of a physical binding effect and reduced coefficient of friction decreases the likelihood that the cavitating agent particles will be “pulled” from the skin layer of the film as the film travels along a surface during processing.

The films are found to be particularly useful as labelstock and especially roll feed labelstock that is typically used in process requiring high speed movement of the film surface across process equipment in printing and label application processes. Roll feed labelstock is used to place labels on certain articles such as bottles or other containers and in particular containers such as soft drink bottles. In a roll feed labeling processes, a roll of film containing labels is used to apply labels to articles. The roll is typically the width of one label to be applied. The labels are applied by unwinding the roll of labels rapidly and cutting individual labels from the roll with a device such as a rotary knife, and transferring the individual labels to a drum where the labels are held in place by a vacuum force. The cut labels are then applied to a line of articles by transferring the labels from the drum, rotating at various speeds, to the moving articles. U.S. Pat. No. 5,413,651 to Otruba provides detail of an exemplary roll feed labeling process.

A problem associated with the use of cavitated skin layer layers on films, particularly labelstock, is that the speed at which the films are processed applies forces to the film that often results in a release of the cavitating agent from the skin layer into the air. This release of the cavitating agent can lead to a cloud or deposit of “dust” of the cavitating agent within the film processing or converting facility. It has been unexpectedly discovered that inclusion of a silicone gum in the cavitated first skin layer of such films enables a film structure in which the release of a cavitating agent is minimized. This result is made possible for three reasons.

First, the coefficient of friction reducing properties of the silicone gum allow for a reduction of the amount of cavitating agent typically used in such films. This results from the fact that calcium carbonate is typically incorporated into a skin layer not only to provide a “white” color to the skin layer but it also reduces the coefficient of friction of the skin layer. With the reduction in coefficient of friction attributable to inclusion of the silicone gum, a lower concentration of calcium carbonate in the skin layer may be used, while maintaining acceptable machinability and whiteness.

Secondly, it has been discovered that the silicone gum in the skin layer functions to bind the calcium carbonate making it more resistant to release of the calcium carbonate from the skin layer into the surrounding air and onto equipment.

Thirdly, the reduction of coefficient of friction of the film moving across a surface during processing reduces forces tending to “pull” the cavitating agent from the cavitated skin layer of the film.

In the various types of label applications described herein a cavitating agent is used in the first skin layer for at least two reasons. The resulting cavitation provides opacity to the labelstock which, when the label is viewed from the printed side provides an opaque background that enhances the color accuracy of images printed on the label. When viewed from the first skin side after application of images on the label, the opacity prevents viewing of the printed image from the backside of the label. For example, if a printed label is applied to a clear soft drink bottle and viewed from the backside of the label by looking through the bottle, the opacity prevents the viewer from seeing a reverse image on the front side of the label. With an opaque first skin layer, a clean white surface is seen on the backside of the label. Of course, it is understood that the opacity may be achieved by inclusion of a pigment such a titanium dioxide rather than a cavitating agent.

The second purpose fulfilled by inclusion of a cavitating agent, particularly calcium carbonate, in the first skin layer is reduction of the coefficient of friction of the first skin of the labelstock brought about by the presence of cavitating agent particles at the surface of the first skin layer. These cavitating agent particles reduce the surface area of a film's first layer in contact with the machine surfaces, thereby reducing the coefficient of friction of the film and improving machinability.

The polymeric films described herein incorporate a core layer and a first skin layer but may also include any number of additional layers such as a second skin layers and intermediate layers. The core may be made from a wide variety of polymeric materials. Exemplary polymeric materials include polyolefins such as polypropylene, polyethylene, ethylene containing copolymers such as ethylene-propylene copolymers, and blends thereof. In one embodiment, the core layer is made from polypropylene and ethylene homopolymer. The term homopolymer refers to polymers that may contain up to 1 wt.% of a comonomer such as ethylene. In one embodiment, the thickness of the core layer is from about 5 μm to about 65 μm. In another embodiment, the thickness of the core layer is from about 5 μm to about 30 μm. In still another embodiment, the thickness of the core layer is from about 5 μm to about 15 μm.

The first skin layer may also incorporate a wide variety of polymeric materials. Exemplary polymeric materials include polyolefins such as polypropylene, polyethylene, polystyrene, ethylene containing copolymers such as ethylene-propylene copolymers, ethylene containing terpolymers such as ethylene-butylene-propylene, and blends thereof. In one embodiment, the thickness of the first skin layer is from about 0.25 μm to about 2 μm. In another embodiment, the thickness of the first skin layer is from about 0.3 μm to about 1 μm. In still another embodiment, the thickness of the first skin layer is from about 0.5 μm to about 0.8 μm.

In one embodiment, the first skin layer comprises a polymeric material selected from medium and high-density polyethylenes, polypropylene homopolymers, copolymers of propylene and ethylene, copolymers of propylene and butylene, and blends thereof. In this embodiment, the core layer incorporates a polymeric material selected from a polypropylene homopolymer, polyethylene homopolymer, and blends thereof.

In another embodiment, the first skin layer comprises a material selected from medium-density polyethylene, high-density polyethylene, and blends thereof and the core layer incorporates a polypropylene homopolymer.

In still another embodiment, the first skin layer comprises medium-density polyethylene and the core layer is comprised of a polypropylene homopolymer.

Useful cavitating agents for inclusion in the core layer include a variety of materials of finely divided particles such as calcium carbonate, polybutene-1 terephthalate (“PBT”), glass beads, polyacrylate, polyester, polyamide, cross-linked polymeric particulates such as polystyrene, cyclic olefin copolymers, and mixtures thereof. Cavitation may also be accomplished through the use of beta-nucleators. Calcium carbonate is a useful cavitating agent in the first skin layer. In one embodiment, the finely divided cavitating agents for use in the core layer and the first skin layer are generally 3-dimensional particles having diameters from about 0.2 μm to about 2.0 μm, as described in U.S. Pat. Nos. 4,632,869, 5,264,277 and 5,288,548. The 3-dimensional particles form microvoids on orientation of the film layer in which they are included. The cavitating agents may be included in the core and first skin layers by any methods known in the art.

In one embodiment, the core layer of the films described herein incorporate from about 2 wt.% to about 30 wt.% of a cavitating agent to produce opacity and provide stiffness to the film. In another embodiment, the core layer of the films described herein incorporate from about 5 wt.% to about 15 wt.% of a cavitating agent. In another embodiment, the core layer is comprises about 5 wt.% to about 15 wt.% of a cavitating agent selected from the group consisting of calcium carbonate, polybutene-1 terephthalate, and mixtures thereof, based upon the weight of the core layer. In still another embodiment, the core layer of the films described herein incorporate from about 8 wt.% to about 13 wt.% of a cavitating agent.

In one embodiment, the skin layer of the films described herein incorporate from about 1 wt.% to about 30 wt.% of calcium carbonate to produce opacity and to reduce the coefficient of friction of the film during processing operations. In another embodiment, the first skin layer of the films described herein incorporate from about 5 wt.% to about 15 wt.% of calcium carbonate. In still another embodiment, the first skin layer of the films described herein incorporate from about 5 wt.% to about 10 wt.% of calcium carbonate.

The silicone gum useful for inclusion in the first skin layer is a high-viscosity polydialkyl siloxane compound. An example of a structure of a silicone gum is HOMe₂SiO(Me₂SiO)ₙSiMe₂OH, in which Me is methyl and n is an integer having a value which can be as much as 10,000.

Silicone gums are not flowable at room temperature, whereas silicone oils are flowable fluids at room temperature. Silicone gums may have the consistency of tough putty or hard deformable plastic. Silicone gums may have a durometer hardness of at least about 5 or a penetration number of about 1500 or less. Penetration number is used to describe the hardness or viscosity of asphalt or bitumen and other substances of similar consistency, with higher values denoting softness or lower viscosity: Corbett, L. W. and R. Urban (1985), Asphalt and Bitumen, Ullmann's Encyclopedia of Industrial Chemistry, W. Gerhartz, Deerfield Beach Florida, USA, VCH Publishers, A.3: 163-188.

The viscosity of silicone gum may exceed 10⁶ cSt, for example, the viscosity of silicone gum may be from about 10 to about 20 million cSt, e.g., about 15 million cSt. Silicone gums may have a Williams plasticity (ASTM D 926) of at least 95.

The high molecular weight and high viscosity of silicone gum impede it from migrating throughout the film structure or from surface to surface. Thus, silicone gum displays less of a transfer effect, which lends the multilayer film improved converting properties. When properly blended and extruded with the polymer of the first skin layer, moreover, the silicone gum is evenly distributed throughout the polymeric material of the first skin layer.

The silicone gum can be in the form of a silicone polymer dispersed in polypropylene or polyethylene. Ultra-high molecular weight silicone gum of this kind is available in masterbatch form from the Dow Corning Corporation, of Midland, Mich., under the product designations “MB50-001” and “MB50-002”.

The silicone gum can be included in the first skin layer in an amount of from about 1.25 wt.% to about 10 wt %, based on the weight of the first skin layer. In the case where the silicone gum is added in masterbatch form, sufficient amounts of masterbatch can be used to ensure that the final level of silicone gum falls within the desired level of from about 1.25 wt.% to about 10 wt.%, based on the weight of the first skin layer.

In evaluating the performance of the silicone gum in the first skin layer, it was unexpectedly determined that the advantages resulting from the inclusion of the silicone gum are not observed at silicone gum levels below 1.25 wt.%, based on the weight of the first skin layer. Moreover, the beneficial effects of the silicone gum in reducing the propensity of the calcium carbonate cavitating agent to be released from the first skin layer were not observed for other cavitating agents such as polybutene-1 terephthatlate (“PBT”) and silicon spheres.

In one embodiment, the silicone gum is included in the first skin layer at a concentration of about 1.25 wt.% to about 10 wt.%, based on the weight of the first skin layer. In a second embodiment, the silicone gum is included in the first skin layer at a concentration of about 2 wt.% to about 8 wt.%, based on the weight of the first skin layer. In still another embodiment, the silicone gum is included in the first skin layer at a concentration of about 2.5 wt.% to about 4 wt.%, based on the weight of the first skin layer. Generally, if the first skin layer includes a copolymer, lower levels of silicone gum perform better.

Although the first skin layer is an opaque layer because of the cavitating effect of the calcium carbonate, the other layers of the film may be clear or opaque. The opacity of the film layers may be achieved by creating voids, in one or more layers of the polymeric film substrate or by other means. Any of the various film layer materials can contain processing aids or inorganic particulates such as titanium dioxide or void initiating agents to enhance the whiteness or color of the substrate or to enhance antiblocking properties. For example, as discussed above, the core layer of the films described herein may include from about 2 wt.% to about 25 wt.% of a cavitating agent. Exemplary void initiators and techniques are disclosed in U.S. Pat. Nos. 5,885,721 and 6,168,826.

As discussed above, titanium dioxide may be included in any of the film layers as a pigment. In three layer film designs, the titanium dioxide is typically included in one of the skin layers. In five layer film designs, the titanium dioxide is typically included in a tie layer. In one embodiment, the titanium dioxide is included in any of the film layers at a concentration of about 2 wt.% to about 18 wt.% of the layer in which the titanium dioxide is included. In another embodiment, the titanium dioxide is included in any of the film layers at a concentration of about 5 wt.% to about 10 wt.% of the layer in which the titanium dioxide is included.

As mentioned, the films described herein may have two or more coextruded layers. For example, the films may be 3-layer polymeric films including the core layer and the first skin layer as well as a second skin layer adjacent to the core layer, opposite the first skin layer. In such an embodiment, the second skin layer may have a thickness of about 0.25 μm to about 2.5 μm and may include a polymeric material selected from the group of a polypropylene, an ethylene-propylene copolymer, an ethylene-butene-propylene terpolymer, and blends thereof. In another embodiment, the second skin layer may have a thickness of about 0.5 μm to about 1 μm. In another embodiment, the second skin layer is comprised of a polymeric material selected from the group consisting of an ethylene-propylene copolymer, an ethylene-butene-propylene terpolymer, and blends thereof.

The second skin layer may be a printable film layer or a metalizable film layer. The second skin may be may also be subjected to one or more various treatments such as flame treatment and corona treatment to enhance printability.

In other embodiments, the films described herein may be 5-layer polymeric films, including the core layer and the first and second skin layers with an intermediate layer disposed between each of the first and second skin layers and the core layer. In one embodiment, the intermediate layers include from about 60 wt.% to about 100 wt.% of a polymeric material selected from a polypropylene homopolymer, propylene copolymers, and blends thereof. In another embodiment, the intermediate layers include from about 70 wt.% to about 100 wt.% of a polypropylene homopolymer.

In certain embodiments, one or both of the intermediate layers may include from about 5 wt.% to about 35 wt.% of a cavitating agent such as calcium carbonate. As discussed above, one or both of the intermediate layers may also include from about 2 wt.% to about 18 wt.% of a pigment such as titanium dioxide.

In all of the embodiments described herein, all of the various film layers described herein may include minor amounts of a variety of additional conventional additive materials designed to perform a variety of functions.

The films described herein may be oriented or hot-blown films made from any of a number of processes. The oriented films may be manufactured in a variety of processes including machine direction orientation (MDO), double bubble, LISIM® (simultaneous orientation), tape bubble, trapped bubble or tenter framing. The hot-blown films are typically manufactured in a simple bubble process.

As mentioned above, it has been unexpectedly determined, that inclusion of a silicon gum in combination with calcium carbonate in the first skin layer of the films described herein serves to improve the machinability of the films during processing. The combination also deters the release of the calcium carbonate cavitating from the first skin layer during processing and handling of the films.

### EXPERIMENTAL EVALUATIONS

The following results of experimental evaluations report the machinability characteristics of various film structures. The results demonstrate the improved machinability of skin layer structures having the silicone gum and calcium carbonate. The results also provide comparative machinability characteristics of other skin layer structures.

In a first set of evaluations, five layer coextruded biaxially oriented film structures with a 0.8 μm first skin layer incorporating a polypropylene homopolymer were prepared. The propylene homopolymer is commercially available from ExxonMobil Chemical under the designation 4612. A 10 μm 4612 polypropylene core layer incorporating 10 wt.% calcium carbonate was provided. Further, the film included a second skin layer having a thickness of 0.8 μm made from an ethylene-propylene copolymer commercially available from Fina under the designation 8573. A 3.8 μm tie layer was provided between the core layer and the first skin layer and was made from 4612 polypropylene incorporating 14% calcium carbonate commercially available from Omya, Inc. under the designation Omya Carb FT. A 3.8 μm tie layer was provided between the core layer and the second skin layer and was made from 4612 polypropylene incorporating 8% titanium dioxide commercially available from Millenium Chemicals under the designation Tiona RCL-4. Certain of the skin layers include a silicone gum available in masterbatch form from Dow Corning Corporation under the designation MB-50-001. Certain skin layers included calcium carbonate added as a masterbatch of 50 wt.% polypropylene and 50 wt.% calcium carbonate or a 70 wt.% calcium carbonate polypropylene masterbatch commercially available from Ampacet under the designation Pearl 2. Certain of the skin layers also included a silicone sphere additive available from GE Silicones under the designation Tospearl 120. Each of the skin compositions are set forth in Table I.

TABLE I
(Comparative)

| PP | CaCO3 wt. % | Si gum wt. | Tospearl | | Machinability |
|---|---|---|---|---|---|
| 4612 | 15 | 0 | 0 | | 4 |
| 4612 | 7.5 | 0 | 0 | | 2 |
| 4612 | 15 | 0 | 0 | | 4 |
| 4612 | 15 | 0 | 0 | | 3 |
| 4612 | 7.5 | 0 | 0 | | 4 |
| 4612 | 7.5 | 0 | 0 | | 3 |
| 4612 | 0 | .35 | 1700 | ppm | 4 |
| 4612 | 0 | .35 | 1700 | ppm | 4 |
| 4612 | 10 | 0 | 0 | | 3 |

Machinability was evaluated by blind comparisons of film layers on a B&H 8000 labeling machine. Skin layers have machinability values of 3-4 are consider to be unacceptable with films having values of 3 experiencing significant processing difficulties and values of 4 representative of films that will not run on conventional processing equipment. From these results, it is seen that adding low levels of silicone gum to the skin layers failed to improve machinability.

In a second set of evaluations, 0.8 μm film layers incorporating a high density polyethylene were prepared. The high density polyethylene is commercially available from Equistar Chemicals, LP under the designation M 6030. Certain of the skin layers include a silicone gum available in masterbatch form from Dow Corning Corporation under the designation MB-50-001. Certain skin layers included a 50 wt.% polypropylene/50 wt.% calcium carbonate masterbatch. Certain of the skin layers also included a silicone sphere additive available from GE Silicones under the designation Tospearl 120. Certain of the formulations incorporated polymethyl methacrylate (PMMA) particles available from Nippon Shokubai under the designation EPOSTAR MA-1002. The skin layer compositions are set forth in Table I.

TABLE II
(Comparative)

| | MA- | CaCO3 | | | |
|---|---|---|---|---|---|
| HDPE | 1002 | wt. % | Si gum wt. | Tospearl | Machinability |
| M6030 | | 5 | 0 | 0 | 4 |
| M6030 | | 10 | 0 | 0 | 0 |
| M6030 | 2000 ppm | 0 | 4 | 2000 ppm | 1 |
| M6030 | 1000 ppm | 0 | 4 | 1000 ppm | 1 |
| M6030 | | 15 | 0 | 0 | 0 |

Machinability of the skin layers was evaluated as indicated above. It is seen that the HDPE skin layers incorporating high levels of calcium carbonate (10%-15%) exhibited superior machinability characteristics. However, at lower levels of calcium carbonate, the HDPE skin layers failed to machine well.

In a third set of evaluations, 0.762 μm film layers incorporating an impact copolymer high density polyethylene were prepared. The impact copolymer is commercially available from Ato Fina under the designation EOD 0125. Certain of the skin layers include a silicone gum available in masterbatch form from Dow Corning Corporation under the designation MB-50-001. Certain skin layers included a 50 wt.% polypropylene/50 wt.% calcium carbonate masterbatch. Certain of the formulations incorporated polymethyl methacrylate (PMMA) particles available from Nippon Shokubai under the designation EPOSTAR MA-1002. The skin layer compositions are set forth in Table III.

TABLE III
(Comparative)

| | | | CaCO3 | | |
|---|---|---|---|---|---|
| Impact CP | MA-1002 | | wt. % | Si gum wt. | Machinability |
| EOD 0125 | 0 | | 25 | 0 | 4 |
| EOD 0125 | 0 | | 15 | 5 | 4 |
| EOD 0125 | 2500 | ppm | 20 | 2.5 | 4 |
| EOD 0125 | 5000 | ppm | 15 | 5 | 4 |
| EOD 0125 | 5000 | ppm | 15 | 0 | 4 |
| EOD 0125 | 5000 | ppm | 15 | 25 | 4 |

Machinability of the skin layers was evaluated as indicated above. It is seen that none of the skin layers incorporating the impact copolymers performed well regardless of the incorporation level of calcium carbonate or silicone gum in isolation.

In a fourth set of evaluations, the 0.8 μm first layer five layer films were prepared with the first skin layer incorporating the 4612 polypropylene homopolymer. The skin layers included a silicone gum available in masterbatch form from Dow Corning Corporation under the designation MB-50-001. The first skin layers also included a 50 wt.% polypropylene/50 wt.% calcium carbonate masterbatch. The skin layer compositions are set forth in Table IV.

TABLE IV

| | CaCO3 | | |
|---|---|---|---|
| PP | wt. % | Si gum wt. | Machinability |
| 4612 | A | 5 | <1 |
| 4612 | A | 0 | >3 |
| 4612 | A | 2.5 | <2 |
| 4612 | A | 5 | <1 |
| 4612 | 15 | 5 | 1 |
| 4612 | 25 | 5 | 0+ |
| 4612 | 5 | 5 | 00++ (best) |

A-Layers included either 5 wt.%, 20 wt.%, or 25 wt.% calcium carbonate.

Machinability of the skin layers was evaluated as indicated above. It is seen that there is a correlation between the silicone gum and calcium carbonate combination and improved machinability. From the data reported in Table I it is seen that none of the polypropylene-based skin layers without this combination exhibited acceptable machinability. However, in the presence of the silicone gum and calcium carbonate combination, superior machinability characteristics in polypropylene skin layers were obtained. Generally, an increase in silicone gum concentration improves machinability. Moreover, it is also observed that favorable machinability characteristics are exhibited when both silicone gum and calcium carbonate are present in the first skin layer and when the calcium carbonate is present at both low and high concentration levels. The low and high concentrations are 5 and 25 wt.%. Less favorable machinability characteristics were observed when a middle range (15 wt.%) calcium carbonate concentration was present with 5 wt.% silicone gum. The favorable machinability characteristics observed at calcium carbonate levels of 5 wt.% indicate that good machinability may be achieved at calcium carbonate levels low enough to help reduce dusting of calcium carbonate from the first skin layer that is more likely to occur at higher calcium carbonate concentrations. The unique combination of silicone gum and calcium carbonate as described herein makes this result achievable.

With respect to the various ranges set forth herein, any upper limit recited may, of course, be combined with any lower limit for selected sub-ranges.

All patents and publications, including priority documents and testing procedures, referred to herein are hereby incorporated by reference in their entireties.

Although the present invention and its advantages have been described in detail, it should be understood that various changes, substitutions, and alterations could be made without departing from the spirit and scope of the invention as defined by the following claims.

1. A polymeric film comprising:
(i) a coextruded polymeric core layer having a first and second surface;
(ii) a coextruded first skin layer having a first and second surface wherein the first surface of the first skin layer is adjacent to the first surface of the core layer; and
wherein the first skin layer comprises about 1 wt.% to about 35 wt.% of calcium carbonate and from about 1.25 wt.% to about 10 wt.% of a silicone gum, based upon the weight of the first skin layer.

2. The polymeric film of claim 1 wherein the core layer has a thickness of about 5 μm and about 65 μm and is comprised of a polymeric material selected from a polypropylene homopolymer, polyethylene homopolymer, and blends thereof and the first skin layer has a thickness of about 0.25 μm to about 2 μm and is comprised of a polymeric material selected from medium and high-density polyethylenes, polypropylene homopolymers, copolymers of propylene and ethylene, copolymers of propylene and butylene, and blends thereof.

3. The polymeric film of claim 2 wherein the core layer is cavitated.

4. The polymeric film of claim 3 wherein the first skin layer comprises about 1 wt.% to about 30 wt.% of calcium carbonate, based upon the weight of the first skin layer.

5. The polymeric film of claim 4 wherein the first skin layer comprises about 2 wt.% to about 8 wt.% of silicon gum, based upon the weight of the first skin layer.

6. The polymeric film of claim 5 wherein silicone gum has a viscosity in the range of 10 to 20 million centistokes.

7. The polymeric film of claim 6 comprising a coextruded second skin layer having a first and second surface wherein the first surface of the second skin layer is adjacent to the second surface of the core layer and wherein the second skin layer is comprised of a polypropylene, an ethylene-propylene copolymer, an ethylene-butene-propylene terpolymer, and blends thereof.

8. The polymeric film of claim 7 wherein one of layers of the film comprises about 2 wt.% to about 18 wt.% of titanium dioxide, based upon the eight of the layer comprising titanium dioxide.

9. The polymeric film of claim 8 wherein the second skin layer has a thickness of about 0.25 μm to about 2.5 μm.

10. The polymeric film of claim 9 comprising a coextruded first intermediate layer comprising about 5 wt.% to about 35 wt.% of calcium carbonate, based upon the weight of the first intermediate layer, between the core layer and the first skin layer and a second coextruded intermediate layer comprising about 2 wt.% to about 18 wt.% of titanium dioxide, based upon the weight of the second intermediate layer, between the core layer and the second skin layer.

11. The polymeric film of claim 8 wherein the second skin layer comprises a polymeric material selected from the group consisting of an ethylene-propylene copolymer, an ethylene-butene-propylene terpolymer, and blends thereof.

12. The polymeric film of claim 11 comprising about 5 wt.% to about 15 wt.% calcium carbonate, based upon the weight of the core layer, in the core layer, about 2.5 wt.% to about 4 wt.% silicon gum, based upon the weight of the first skin layer, in the first skin layer, about 5 wt.% to about 10 wt.% titanium dioxide, based upon the weight of the second skin layer, in the second skin layer, and wherein the second skin layer is metalized.

13. A labelstock comprising a multiple layer labelstock comprising:
(i) a coextruded polymeric core layer having a first and second surface;
(ii) a coextruded first skin layer having a first and second surface; and
wherein the first surface of the first skin layer is adjacent to the first surface of the core layer and wherein the skin layer comprises 5 wt.% to 15 wt.% of calcium carbonate and about 1.25 wt.% to about 10 wt.% of a silicone gum, based upon the weight of the first skin layer.

14. The labelstock of claim 13 wherein the core layer has a thickness of about 5 μm to about 65 μm and is comprised of a polymeric material selected from a polypropylene homopolymer, polyethylene homopolymer, and blends thereof and the first skin layer has a thickness of about 0.25 μm to about 2 μm and is comprised of a polymeric material selected from medium and high-density polyethylenes, polypropylene homopolymers, copolymers of propylene and ethylene, copolymers of propylene and butylene, and blends thereof.

15. The labelstock film of claim 14 wherein the core layer is cavitated.

16. The labelstock of claim 13 wherein the labelstock is a roll feed labelstock.

17. The labelstock of claim 16 wherein the core layer has a thickness of about 5 μm to about 30 μm and the skin layer has a thickness of about 0.3 μm to about 1 μm.

18. The labelstock of claim 17 wherein the core layer is comprises about 5 wt.% to about 15 wt.% of a cavitating agent selected from the group consisting of calcium carbonate, polybutene-1 terephthalate, and mixtures thereof, based upon the weight of the core layer.

19. The labelstock claim 18 wherein the first skin layer comprises from 5 wt.% to 10 wt.% of calcium carbonate, based upon the weight of the first skin layer.

20. The labelstock film of claim 19 wherein the first skin layer comprises from about 2 wt.% to about 8 wt.% of silicon gum, based upon the weight of the first skin layer, having a viscosity in the range of 10 to 20 million centistokes, based upon the weight of the first skin layer.
